(19) United States
(12) Patent Application Publication
(10) Pub. No.: US 2007/0118261 A1
(43) Pub. Date: May 24, 2007

(54) Vehicle for simulating impaired driving

(75) Inventors: Michael Aguilar, Verona, WI (US); Thomas Hartmann, Prairie Du Sac, WI (US); Patrick Flaherty, Bettendorf, IA (US)

Correspondence Address: QUARLES & BRADY LLP, 33 E. MAIN ST, SUITE 900, P.O BOX 2113, MADISON, WI, 53701-2113, US

(73) Assignee: Innocorp, Ltd.

(21) Appl. No.: 11/654,078

(22) Filed: Jan. 17, 2007

Related U.S. Application Data
(62) Division of application No. 10/795,572, filed on Mar. 8, 2004.
(60) Provisional application No. 60/453,097, filed on Mar. 7, 2003.

(51) Int. Cl. B60G 17/018

(52) U.S. Cl. 701/37

(57) ABSTRACT

The present invention provides a motorized vehicle of the type having a chassis supported by a set of wheels, at least one of which being driven by a motor. The vehicle is operable to simulate impaired driving. In particular, a vehicle control system is provided that controls at least one aspect of vehicle operation in response to an operator input intended to produce an expected vehicular response. An impairment simulator is provided that is operable in a first mode whereby the vehicle control system produces the expected vehicular response, and a second mode whereby the vehicle control system produces a response inconsistent with the expected vehicular response.

### CROSS-REFERENCE TO RELATED APPLICATIONS

This application claims priority to U.S. Provisional Application Ser. No. 60/453,097, the disclosure of which is hereby incorporated by reference as if set forth in its entirety herein.

### STATEMENT REGARDING FEDERALLY SPONSORED RESEARCH OR DEVELOPMENT

Not applicable.

### BACKGROUND OF THE INVENTION

The present invention relates to motorized vehicles, and in particular relates to a vehicle that simulates the impairing effect of an intoxicant on an operator's driving skills.

Substantial effort is undertaken by educators, law enforcement personnel, safety promoting organizations, and the like to convince people, particularly young people, of the hazards associated with operating a motor vehicle while under the influence of intoxicants such as alcohol, legal-, and illegal drugs. It is particularly challenging to provide a meaningful firsthand experience of the impairing effects of an intoxicant, such as alcohol or other drugs, insofar as one typically cannot induce impairment in a subject with the intoxicant. Even if one could, it would be improper for the subject to then operate a motor vehicle while impaired. Furthermore, an impaired operator may not appreciate in real-time the impairing effect of the intoxicant on his or her driving skills.

What is therefore needed is a method and apparatus for enabling an unimpaired operator to experience firsthand simulated motor vehicle operation by an impaired operator, where the method and apparatus can be readily be employed in a controlled setting that does not put the operator at risk and at the same time effectively conveys the outcome of impaired motor vehicle operation.

### BRIEF DESCRIPTION OF THE SEVERAL VIEWS OF THE DRAWINGS

FIG. 1 is a front perspective view of a motorized vehicle operating including an impairment simulator constructed in accordance an embodiment of the invention.

FIG. 2 is a rear perspective view of the vehicle illustrated in FIG. 1; and

FIG. 3 is a schematic illustration of control operations for the impairment simulator.

### SUMMARY OF THE INVENTION

In accordance with one aspect of the invention, a motorized vehicle is provided that is operable to simulate impaired driving. The vehicle includes a chassis supported by a set of wheels, at least one of which being driven by a motor. A vehicle control system is provided that controls at least one aspect of vehicle operation in response to an operator input intended to produce an expected vehicular response. An impairment simulator is operable in a first mode whereby the vehicle control system produces the expected vehicular response, and a second mode whereby the vehicle control system produces a response inconsistent with the expected vehicular response.

The foregoing and other aspects of the invention will appear from the following description. In the description, reference is made to the accompanying drawings which form a part hereof, and in which there is shown by way of illustration, and not limitation, a preferred embodiment of the invention. Such embodiment does not necessarily represent the full scope of the invention, however, and reference must therefore be made to the claims herein for interpreting the scope of the invention.

### DESCRIPTION OF THE INVENTION

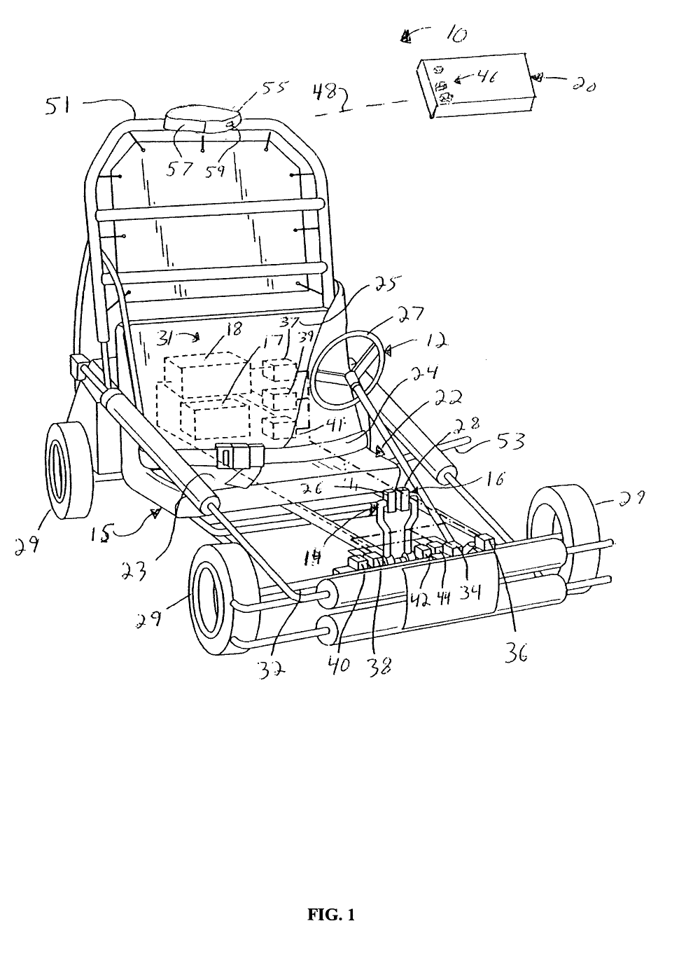

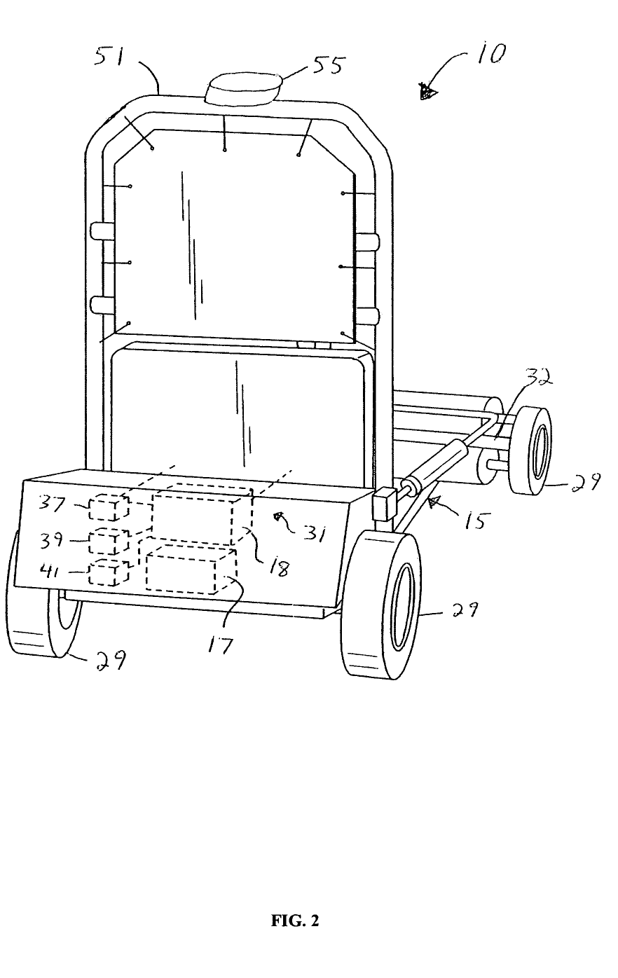

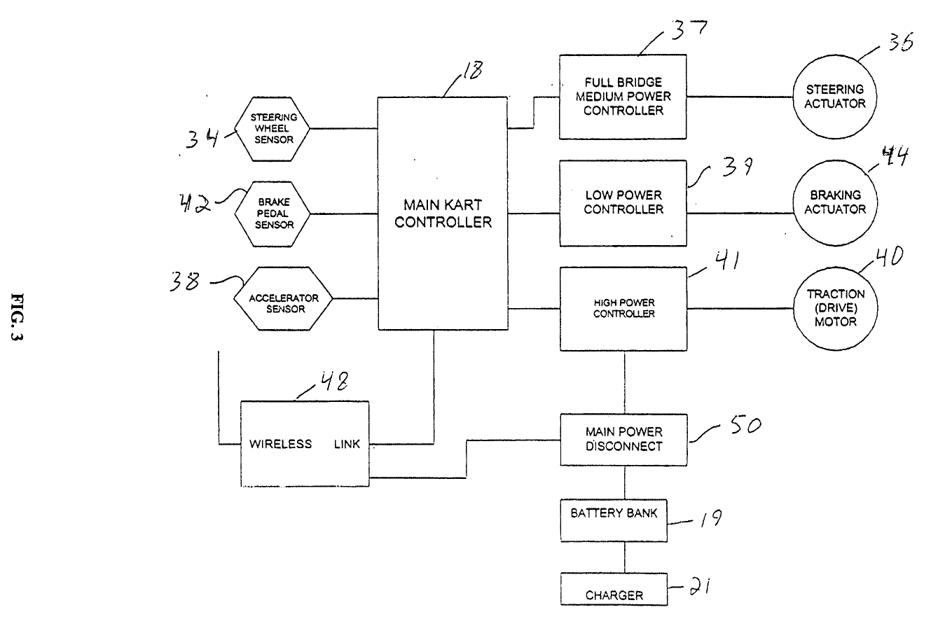

Referring initially to FIGS. 1 and 2, a motorized vehicle 10 for use in simulating an impaired driving experience of the vehicle operator includes at least one, and preferably a plurality, of vehicle control systems including, but not limited to, a steering system 12, a propulsion (acceleration) system 14, and a braking system 16 carried by a chassis 15. Chassis 15 is supported by a plurality of ground-engaging wheels 29, at least one of which driven to rotate under power provided by a conventional battery-operated motor 17. The battery 19 and a corresponding battery charger 21 are illustrated schematically in FIG. 3.

Steering system 12 receives an operator input in the form of, for instance, movement of a conventional steering apparatus, such as steering wheel 27, and controls the orientation of front wheels 29 and thus the direction of vehicle travel. Propulsion system 14 receives an operator input in the form of, for instance, the depression or release of an acceleration pedal 26, and controls linear vehicle acceleration. Braking system 16 receives an operator input in the form of, for instance, depression or release of a brake pedal 28, and controls forced vehicle linear deceleration.

The performance of systems 12-16 is controlled by an impairment simulator 31 that includes an onboard controller 18 in accordance with the preferred embodiment. As will become apparent from the description below, controller 18 is configured to receive signals from a remote controller 20 that can be operated by a person other than the vehicle operator to subtly or markedly alter the performance of systems 12-16 as desired.

Vehicle 10 can be manufactured in a variety of ways as will be apparent to the skilled artisan, and the appearance of the vehicle is not considered to be a limitation on the scope of the invention. Vehicle 10 can be in the form of, for instance, a go-kart of the type well known in the art. Small size and shape and low weight offer convenience in transporting vehicle 10 from location to location for use, typically in a safety or intoxicant awareness presentation. Vehicle 10 can be conveniently designed to be conveyed in a small truck or minivan and, for example, is 48″w×76″l×30″h and weighs approximately 400 pounds with its batteries installed. Vehicle 10 is thus suitable for transportation using a minivan from which the rear seats have been removed, or any suitable trailer.

Vehicle 10 includes a seating apparatus 22 including a bench 23 and a seatback 25 that support an operator at a location within reach of systems 12-16. Preferably, the vehicle is sufficiently wide and seating apparatus 22 is configured to permit a passenger to be carried in addition to the operator during operation. Seating apparatus 22 carries a safety belt 24 that can be fastened by the operator in the usual manner.

During operation, in accordance with the preferred embodiment, impairment simulator 31 can be operated in a first, NORMAL mode, wherein the operator inputs (e.g., steering, accelerating, and braking) yield expected and predictable vehicular responses. In a second mode, referred to herein as IMPAIRED mode, vehicle 10 responds to the operator inputs in an unexpected and unpredictable manner dissociated from the normal response, and inconsistent with the operator input. The operator must then compensate for the unexpected response in order to maintain control of vehicle 10, thereby simulating the behavior of an impaired driver operating a motor vehicle.

Referring also to FIG. 3, vehicular control systems 12-16 are preferably “drive by wire” systems, meaning that no direct mechanical linkages connect the operator's controls to the vehicle control subsystems. Rather, controller 18 includes a processor (not shown) that executes a stored program to control vehicle operation.

For example, steering wheel 27 preferably is not mechanically connected to tie rod(s) 32 that control the wheels 29, but rather to a sensor 34 that senses the position of the steering wheel 27 based on the operator steering input. Sensor 34 produces an output reflecting the operator input. The sensor output is read by controller 18 which, in turn, controls the vehicular response to the operator steering input. Controller 18 outputs a control signal that is received by a dedicated steering controller 37 which, in turn, outputs a command to a steering actuator 36. Actuator 36 is coupled to the tie rod(s) 32 which are connected between front wheels 29 in order to steer the vehicle 10.

Likewise, acceleration pedal 26 is not directly connected to the vehicle throttle (not shown), but rather to a sensor 38 that senses the position of pedal 26 based on the operator acceleration input. Sensor 28 produces an output that is read by controller 18 which, in turn, controls the vehicular response to the operator acceleration input. Controller 18 outputs a control signal that is received by a dedicated acceleration controller 39. Controller 39, in turn, outputs a command to an actuator 40 that opens and closes the throttle.

Brake pedal 28 also is not directly connected to the brake pads (not shown), but rather to a sensor 42 that senses the position of pedal 28 based on an operator braking input. Sensor 28 produces an output reflecting the operator input. The sensor output is read by controller 18 which, in turn, controls the vehicular response to the operator braking input. Controller 18 outputs a control signal that is received by a dedicated braking controller 41. Controller 41, in turn, outputs a command to an actuator 44 that is operatively connected to the brake pads (not shown) to control vehicle braking operations.

It should thus be appreciated that, during operation, steering, acceleration, and deceleration operations can be controlled by simulator 31 to alter the operator inputs and to simulate, for example, slower driver reactions or other desired effects for the simulation. While systems 12-16 are considered preferred because of the substantial operational flexibility they permit, it will be appreciated that other vehicle control systems, such as mechanical control systems can be employed in place of electronic controls to offer comparable control over operator inputs. Suitable mechanical control systems including hydraulic dampeners, shock absorbers, or a Pitman Arm having two ends that connects a steering, braking or propulsion system at the first end to a variable restrictor having a movable piston at the second end. A skilled artisan will further appreciate that controller 18 could alternatively communicate directly to the corresponding vehicle system actuators to produce the desired vehicular response, thereby avoiding the need for dedicated system controllers.

When operating in NORMAL mode, controller 18 outputs control signals that are consistent with the given operator input such that vehicle 10 responds as the operator would expect. In NORMAL mode, the operator has full control of the steering, propulsion and braking systems 12-16. For instance, when the operator turns steering wheel 27, vehicle 10 responds appropriately and immediately. Likewise, the propulsion and braking systems 14 and 16 react predictably in real time to the operator's actions. This mode simulates driving under normal conditions without impairment.

In accordance with the preferred embodiment, operating in IMPAIRED mode, controller 18 outputs control signals that are dissociated from the normal response and inconsistent with the operator input. In particular, the vehicular responses are preferably related, but modified, with respect to the sensed operator inputs in a predetermined manner. For instance, when the operator input is in the form of steering wheel rotation intended to promptly turn the vehicle an expected amount, the control signals can cause actuator 36 to turn front wheels 29 more or less than the expected amount as determined by corresponding sensor 34. Likewise, controller 18 can output control signals to actuator 40 that actuates propulsion system 14 to accelerate vehicle 10 more or less than the expected amount as sensed by the position or movement of acceleration pedal 26. Additionally, controller 18 can output control signals to actuator 44 that causes braking system 16 to decelerate vehicle 10 more or less than the amount sensed from brake pedal 28. It should be further appreciated that control signals can delay actuation of the corresponding system 12-16 by a predetermined amount to simulate the delayed reactions of an impaired operator.

The skilled artisan will appreciate that the operation of systems 12-16 in IMPAIRED mode can be interlinked in a manner that will result in additional unexpected and unpredicted vehicular behaviors in response to an operator's control input(s). For instance, controller 18 may produce control signals that operate acceleration system 14 or braking system 16 in tandem with steering system 14 in a manner inconsistent with operator inputs.

The control signals during impairment mode can be computed based on a desired degree of simulated operator impairment, it being appreciated that enhanced impairment increases the variance and delay between the control signals and the sensed operator inputs. These operational modifications can simulate the effects of operating a vehicle while impaired, and can convey to the operator a sensation of being unable to control the vehicle.

In accordance with the preferred embodiment, motor 17 can be disabled 18 by an emergency brake lever 53 that extends outwardly from chassis 15 within reach of the vehicle operator. Lever is movable between a first position that provides an emergency brake overriding controller 18, and a second position that enables operation of vehicle 20 as described above.

Referring now FIGS. 1 and 3 in particular, simulator 31 preferably includes a remote controller 20 that is operated by a user disposed outside, but within a predetermined proximity of, vehicle 10. Controller 20 preferably communicates with vehicle controller 18 via an infrared or, alternatively, a wireless Radio Frequency (RF) link. In particular, a receiving unit 55 is mounted onto roll bar 48, preferably via one or more u-clamps that receive the upper horizontal surface of the roll bar. Receiving unit 55 receives input from remote controller 20, and forwards the input to central controller 18. Receiving unit 55 further includes an LED display 57 that provides information regarding the operational status of vehicle (e.g., whether in normal or impaired mode). Receiving unit 55 further includes a traditional stop switch 59 that is movable between a first position, whereby operation of motor 17 is prevented, and a second position whereby vehicle operation is permitted.

Controller 20 includes a set of user-actuated output devices 46, such as buttons, key fobs, or the like, that can be used for multiple purposes. For instance, an output 46 can be actuated that establishes a required constant link 48 with controller 18 that authorizes vehicle operation. Link 48 can be established by activating an output (e.g., by depressing a button or turning a key fob) once on remote controller 20. Alternatively, the output must be constantly engaged to maintain link 48. If the output becomes disengaged, or if vehicle 10 is disposed outside a predetermined range of remote controller 20 (for instance 100 feet), link 48 will become broken and vehicle 10 will be rendered inoperable. If vehicle 10 is in motion and link 48 is broken, vehicle 10 will be brought to a halt and will not operate until link 48 is again established. In particular, a “main power disconnect” 50 will be activated when link 48 is broken. Disconnect 50 causes dedicated propulsion controller 39 to prevent further vehicle acceleration, either by controller 18 or the vehicle operator. Controller 18 and dedicated steering and braking systems 12 and 16 function after disconnect 50 is activated to enable the vehicle operator to steer and brake vehicle 10 in a normal and predictable manner.

In addition, remote control outputs 46 can be actuated to specify whether controller 18 is to operate in NORMAL or IMPAIRED mode. Additional control functions can also be accorded to the remote control 20, with the onboard controller 18 acting to carry out received instructions. For instance, remote controller 20 can control the level of impairment to be simulated, along with other control responsibilities as appreciated by the skilled artisan. Furthermore, the remote controller 20 can be operated by the user to identify which of the vehicle systems 12-16 are to be affected, and whether the affected systems are to be interlinked, during IMPAIRED mode.

Vehicle 10 also preferably includes safety features, both to promote safe operation and to remind the operator of the importance of such features as safety belt 24 and the like. Vehicle 10 can also be engineered to prevent rollover by keeping the center of gravity close to the ground, providing a wide wheelbase, and limiting the maximum vehicle speed to an acceptably low rate such as 4-10 mph. A roll bar 51 is also provided.

A skilled artisan will appreciate that, while simulator 31 has been described above as including controller 18 along with remote controller 20 and a plurality of sensors, controllers, and actuators in accordance with the preferred embodiment, the present invention is intended to encompass any apparatus capable of operating a vehicle in a first normal response mode whereby the vehicle response corresponds to operator inputs to effect predictable vehicle operation, and a second impaired response mode whereby vehicular responses are inconsistent with the vehicular response.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements included within the spirit and scope of the invention, as set forth by the appended claims.

1. A motorized vehicle operable to simulate impaired driving, comprising:
a chassis supported by a set of wheels, at least one of which being driven by a motor;
a vehicle control system that controls at least one aspect of vehicle operation in response to an operator input intended to produce an expected vehicular response; and
an impairment simulator operable in a first mode whereby the vehicle control system produces the expected vehicular response, and a second mode whereby the vehicle control system produces a response inconsistent with the expected vehicular response.

2. The motorized vehicle as recited in claim 1, wherein the operator input is sensed by the vehicle control system.

3. The motorized vehicle as recited in claim 2, wherein the inconsistent response is related to the sensed operator input.

4. The motorized vehicle as recited in claim 3, wherein the inconsistent response is delayed with respect to the expected response.

5. The motorized vehicle as recited in claim 1, wherein the vehicle control system is selected from the group consisting of a steering system, a vehicle propulsion system, and a braking system

6. The motorized vehicle as recited in claim 5, wherein the vehicular response is caused by more than one interlinked control system.

7. The motorized vehicle as recited in claim 5, wherein the impairment simulator comprises a central controller providing a control signal to an actuator of the control system.

8. The motorized vehicle as recited in claim 7, wherein the system further comprises a sensor that senses the operator input and provides a control signal to the controller.

9. The motorized vehicle as recited in claim 7, wherein the control signals from the central controller are received at a dedicated controller that outputs a command to the actuator of the system.

10. The motorized vehicle as recited in claim 7, wherein the impairment simulator communicates with a remote controller operable to begin vehicle operation.

11. The motorized vehicle as recited in claim 10, further comprising a link that is established when the vehicle and the remote controller are within a predetermined proximity.

12. The motorized vehicle as recited in claim 11, wherein vehicle acceleration is prevented when the link is broken.

13. The motorized vehicle as recited in claim 10, wherein the remote controller can be actuated to operate the simulator in a mode wherein the steering system, acceleration system, and braking system operate in a manner in proportion with the operator input.

14. The motorized vehicle as recited in claim 1, wherein the inconsistent response simulates operation of the vehicle by an impaired driver.

15. A motorized vehicle assembly configured to simulate impaired driving, comprising:
a chassis supported by a set of wheels, at least one of which being driven by a motor;
a vehicle control assembly operable to control at least one aspect of vehicle operation, the assembly including:
i. a sensor sensing an operator input and providing an output in response thereto;
ii. an actuator providing a vehicular response in response to a control signal; and
a controller receiving the sensor output and providing a control signal in response thereto, wherein the controller operates in a first mode whereby the control signal causes the vehicle control assembly to produce an expected response consistent with the operator input and a second mode whereby the control signal causes the vehicle control assembly to respond in a manner inconsistent with the operator input.

16. The motorized vehicle as recited in claim 15, wherein the aspect of vehicle operation is selected from the group consisting of vehicle steering, acceleration, and braking.

17. The motorized vehicle as recited in claim 15, wherein the inconsistent response is related to the sensed operator input.

18. The motorized vehicle as recited in claim 17, wherein the inconsistent response is delayed with respect to the expected response.

19. The motorized vehicle as recited in claim 15, wherein the vehicular response is caused by more than one interlinked vehicle control assembly.

20. The motorized vehicle as recited in claim 15, wherein the vehicle control assembly further comprises a dedicated controller receiving the control signal and outputting a command to the actuator.

21. The motorized vehicle as recited in claim 15, wherein the impairment simulator communicates with a remote controller operable to begin vehicle operation.

22. The motorized vehicle as recited in claim 21, further comprising a link that is established when the vehicle and the remote controller are within a predetermined proximity.

23. The motorized vehicle as recited in claim 22, wherein vehicle acceleration is prevented when the link is broken.

24.-40. (canceled)
